(19) United States
(12) Patent Application Publication
(10) Pub. No.: US 2024/0177957 A1
(43) Pub. Date: May 30, 2024

(54) SWITCHING DEVICE

(71) Applicant: TDK Electronics AG, München (DE)

(72) Inventors: Robert Hoffmann, Berlin (DE); Robert Minkwitz, Berlin (DE)

(21) Appl. No.: 18/551,474

(22) PCT Filed: Feb. 7, 2022
(86) PCT No.: PCT/EP2022/052881

§ 371 Date: Sep. 20, 2023

(30) Foreign Application Priority Data
Mar. 24, 2021 (DE) 10 2021 107 381.2

(51) Int. Cl. H01H 50/54

(52) U.S. Cl. CPC H01H 50/54

(57) ABSTRACT

In an embodiment a switching device includes at least two contacts in a switching chamber, wherein the at least two contacts have a fixed contact and a movable contact, wherein each of the contacts has a contact surface with at least one contact region on a contact side, and wherein at least one of the contacts has at least one recess.

### CROSS-REFERENCE TO RELATED APPLICATIONS

This patent application is a national phase filing under section 371 of PCT/EP2022/052881, filed Feb. 7, 2022, which claims the priority of German patent application 102021107381.2, filed Mar. 24, 2021, each of which is incorporated herein by reference in its entirety.

### TECHNICAL FIELD

A switching device is specified.

### BACKGROUND

The switching device is embodied, in particular, as an electromagnetically acting, remotely actuated switch that can be operated by electrically conductive current. The switching device can be activated via a control circuit and can switch a load circuit. In particular, the switching device can be designed as a relay or as a contactor, in particular as a power contactor. Particularly preferably, the switching device can be designed as a gas-filled power contactor.

One possible application of such switching devices, in particular power contactors, is the opening and disconnection of battery circuits, for example in motor vehicles such as electrically or partially electrically operated motor vehicles or in applications in the field of renewable energies.

In its function as a safety component, a contactor is usually used in combination with a fuse between a battery, such as a lithium-ion battery, and an electric motor and must be able to disconnect the power source from the load in the event of malfunction. Today, such systems typically operate at voltages of about 450 V. In a next generation of such systems, the electrical voltage can be as high as 800 V. Beyond that, for example in special applications, up to 1500 V DC are required.

The higher the electrical voltage of the application, the greater the challenges posed to the design of the contactor, which must interrupt high currents at said high voltages in the event of a fault. Furthermore, it is also required that even after disconnecting high loads, the electrical parameters of the switching device remain close to the original or new state. This applies in particular to the contact resistance of the switching device, which is decisive for the heating of the entire device during normal operation and has a considerable influence on further performance and service life.

If the contacts of the switching device are separated under load, i.e. current flow, electric arcs occur which can damage the surfaces of the contacts by melting. This damage means that the surfaces of the contacts can no longer lie optimally on each other and that the contact resistance increases when the contacts are closed again.

In order to remove arcs from the contact regions as quickly as possible and to extend the arc gap, so-called blowing magnets are usually used which can deflect the arcs in certain directions depending on the direction of the current. For example, suitable switching chamber geometries and magnet arrangements can be used to deflect arcs in predetermined directions. Depending on the configuration, this can even be done independently of the current direction. Thus, depending on the magnetic deflection configuration and, if applicable, depending on the current flow direction, arcs can be forced to different sides as seen from the contacts or can adhere to different areas of the contacts. Therefore, unevenness can also occur at different positions, which can lead to wear and to an increase in contact resistance. It is also known, for example, to configure a movable contact so short that it covers only about half of fixed contacts. This design can lead to arcs causing damage far to outside of the fixed contacts, which is not in the actual contact region when the contacts are closed again. However, this mechanism is not effective against damage to the movable contact, which can very well affect contact resistance upon reclosure. Another disadvantage is a reduced contact region, which can lead to reduced heat dissipation and greater local heating.

### SUMMARY

Embodiments provide a switching device.

According to at least one embodiment, a switching device comprises at least two contacts, which can also be referred to as first contact and second contact, wherein one of the contacts is a fixed contact and the other of the contacts is a movable contact. Accordingly, the switching device comprises at least one fixed contact and at least one movable contact. The at least one fixed contact and the at least one movable contact are intended and configured to switch on and off a load circuit connectable to the switching device.

According to at least one further embodiment, one of the contacts, which can also be referred to hereinafter as the first contact, has at least one contact region. The first contact can, for example, be a fixed contact of the switching device. Alternatively, the first contact can be a movable contact of the switching device. The first contact is intended and configured to make a galvanic contact connection with a further contact, which can also be referred to hereinafter as a second contact, when the contacts are in a suitable position relative to one another. In particular, the second contact can also have a contact surface with a contact region, so that the contact region of the first contact and the contact region of the second contact come into mechanical contact with each other when the contacts are in a suitable position relative to each other and are thus galvanically connected to each other. In particular, each of the contacts can have a contact face with at least one contact region.

The movable contact can be moved in the switching device between a non-through-connecting state and a through-connecting state of the switching device in such a way that, in the non-through-connecting state of the switching device, the movable contact is spaced apart from the at least one fixed contact and is thus electrically isolated and, in the through-connecting state, has a mechanical contact to the at least one fixed contact and is thus electrically connected to the at least one fixed contact. The mechanical contact between the movable contact and the fixed contact in the through-connecting state can be present in particular between a contact region of the movable contact and a contact region of the fixed contact. Particularly preferably, the switching device has at least two fixed contacts which are arranged separately from one another in the switching device and which in this way can be electrically conductively connected to one another or electrically separated from one another by the movable contact, depending on the state of the movable contact.

According to a further embodiment, the switching device has a housing in which the contacts, i.e. the at least one movable contact and the at least one fixed contact or the at least two fixed contacts, are arranged. The movable contact can in particular be arranged completely in the housing. The fact that a fixed contact is arranged in the housing can mean in particular that at least the contact region of the fixed contact, which is in mechanical contact with the movable contact in the through-connecting state, is arranged inside the housing. For connecting a supply line of a circuit to be switched by the switching device, a fixed contact arranged in the housing can be electrically contactable from outside, i.e. from outside the housing. For this purpose, a fixed contact arranged in the housing can protrude with a part from the housing and have a connection possibility for a supply line outside the housing.

According to a further embodiment, the contacts of the switching device are arranged in a gas atmosphere in the housing. In particular, this can mean that the at least one movable contact is arranged completely in the gas atmosphere in the housing and that furthermore at least parts of the fixed contact or fixed contacts, for example the contact region or the contact regions of the fixed contact or the fixed contacts, are arranged in the gas atmosphere in the housing. Accordingly, the switching device can particularly preferably be a gas-filled switching device such as a gas-filled contactor.

According to a further embodiment, the contacts, i.e. the at least one movable contact completely as well as at least parts of the fixed contact or the fixed contacts, are arranged in a switching chamber inside the housing, in which the gas, i.e. at least part of the gas atmosphere, is located. The gas can preferably have a content of at least 50% H₂. In addition to hydrogen, the gas can comprise an inert gas, particularly preferably N₂ and/or one or more noble gases.

According to a further embodiment, the at least one movable contact can be moved by means of a magnetic armature. For this purpose, the magnetic armature can in particular have a shaft that is connected at one end to the movable contact in such a way that the movable contact can be moved by means of the shaft, i.e. is moved by the shaft when the latter is moved. In particular, the shaft can project into the switching chamber through an opening in the switching chamber. The magnetic armature can be movable by a magnetic circuit to affect the switching operations described above. For this purpose, the magnetic circuit can comprise a yoke having an opening through which the shaft of the magnetic armature projects. The shaft can preferably comprise or be made of stainless steel. The yoke can preferably comprise or be pure iron or a low-doped iron alloy.

According to a further embodiment, each of the contacts of the switching device has a respective contact side on which at least one contact region is arranged. The contact region of each of the contacts can in particular be that part of a surface on the contact side of the respective contact that, in the case of normal operation of the switching device, is intended and configured to make mechanical contact with a further contact when the switching device is switched on. The surface with the contact region is also referred to here and in the following as the contact region, whereby not every area of the contact region has to be configured as a contact region.

In particular, the movable contact can have a contact surface that has an elongated configuration, particularly in the shape of a rectangle or approximating the shape of a rectangle, such as a rectangle with beveled or rounded corners. A portion of the surface on the contact side, that is, a portion of the contact surface, can form the contact region. If the movable contact is intended and configured to contact at least two fixed contacts, the contact surface has at least two contact regions that can be separated by one or more surface areas that do not form contact regions. The at least one fixed contact can have a contact surface that is, for example, round, such as a circular shape, or approximates such a shape, and that at least partially or preferably entirely forms the contact region. For example, the contact region of a fixed contact can comprise at least 70% or at least 80% or at least 90% of the contact region.

In particular, the contact side of the at least one movable contact can face the at least one fixed contact and the contact side of the at least one fixed contact can face the at least one movable contact. The contact side of a contact, i.e. in particular the contact surface, can preferably have a main extension plane along which the contact surface extends. Directions parallel to the contact side and thus parallel to the main extension plane of the contact side can also be referred to here and in the following as lateral directions. A direction perpendicular to the contact side and thus perpendicular to the main extension plane of the contact side can be referred to herein and in the following as a vertical direction. The contacts can be surrounded and bounded in the lateral directions by one or more outer surfaces.

For example, a contact region of a contact can be a flat bearing surface of the contact region. Furthermore, the contact region can also have or be a special geometric shape, such as an elevation or depression, and/or a different material compared to other areas of the contact.

According to a further embodiment, at least one contact of the switching device has at least one recess on the contact side. This means that the contact surface does not extend to an outer surface bounding the contact in the lateral direction, but is separated from the outer surface by a step or chamfer, for example. The at least one contact with the at least one recess can preferably be a movable contact. Alternatively or additionally, a fixed contact can also have at least one recess. A contact region of a contact surface of a contact can be directly adjacent to a recess in one or more directions, respectively.

For example, the recess can thus be formed by a groove or chamfer that runs along an imaginary edge that would be formed by the contact surface and an outer surface and that no longer exists between the contact surface and the outer surface due to the groove or chamfer. The recess can form two outer edges, a first outer edge of which is adjacent to the contact surface and a second outer edge of which is adjacent to the outer surface. The first and second outer edges can be interconnected by one or more recess surfaces.

The height of the recess, i.e. the distance in the vertical direction between the first outer edge and the second outer edge, is denoted by H in the following. The width of the recess, i.e. the distance in lateral direction between the first outer edge and the second outer edge, is denoted as B in the following. A total thickness of the contact in the vertical direction is denoted below as D.

The recess can, for example, have or be formed by a rabbet, chamfer, concave fillet or a combination thereof. The chamfer can be an external chamfer or an internal chamfer.

For example, the recess can be formed by an outer chamfer, i.e. by a chamfer in the area of an outer edge between the contact surface and the outer surface that is no longer present due to the chamfer. In this case, the first and second outer edges are connected to each other by a planar recess surface oriented at an angle to the contact surface and to the outer surface, which recess surface can enclose an angle of greater than or equal to 10° and less than or equal to 80°, and particularly preferably 45°, with the main plane of extension of the contact side, i.e. with the contact surface. The ratio B/H is preferably greater than or equal to 0.2 and less than or equal to 5 and particularly preferably 1. Furthermore, the ratio H/D is preferably greater than 0 and less than or equal to 0.8 and particularly preferably greater than or equal to 0.1 and less than or equal to 0.5.

Furthermore, the recess can be formed by a fillet, i.e. by a groove with a circular cross-section in the area of an outer edge between the contact surface and the outer surface that is no longer present due to the groove. In this case, the first and second outer edges are connected to each other by a curved recess surface, preferably with a cross-section corresponding to a circular section. The fillet can have a radius R, the ratio R/D being preferably greater than or equal to 0.05 and less than or equal to 2. The ratio B/H is preferably greater than or equal to 0.2 and less than or equal to 10 or less than or equal to 5 and more preferably 1. Furthermore, the ratio H/D is preferably greater than 0 and less than or equal to 0.8 and more preferably greater than or equal to 0.1 and less than or equal to 0.5.

Furthermore, the recess can be formed by a step such that a first recess surface is adjacent to the contact surface and forms with the contact surface the first outer edge having a first angle, while a second recess surface is adjacent to the outer surface and forms with the outer surface a second outer edge having a second angle. The first and second recess surfaces can include a third angle. The first, second and third angles can be equal to or different from each other and each can be greater than or equal to 90° and less than 180º and preferably each can be 90°. Particularly preferably, the first recess surface can be at least partially or completely parallel to the outer surface. Furthermore, the second recess surface can be at least partially or completely parallel to the contact surface. When the first and second angles are each 90°, the dimension H can correspond to the difference in height in the vertical direction between the second recess surface and the contact surface, and the dimension B can correspond to the distance between the outer surface and the first side surface.

For example, the recess can have a rabbet or be formed by a rabbet. In this case, the transition between the first and second recess surfaces can be formed by an inner edge, wherein the third angle is preferably 90°. The first and second angles in this case can preferably also be 90° each. The ratio B/H is preferably greater than or equal to 0.2 and less than or equal to 5 and particularly preferably 1. Furthermore, the ratio H/D is preferably greater than 0 and less than or equal to 0.8 and particularly preferably greater than or equal to 0.1 and less than or equal to 0.5.

Furthermore, the recess can have an internal chamfer. In this case, the recess can be formed by a combination of a rabbet and a chamfer. Compared to a rabbet with an inner edge between the first and second recess surfaces, the transition between the first and second recess surfaces is formed here not by an inner edge but by a chamfer in the form of the inner chamfer, so that a third recess surface is formed between the first and second recess surfaces. In this case, the first and second recess surfaces are connected to each other by a planar recess surface oriented at an angle to the first and second recess surfaces, which can include an angle of greater than or equal to 10° and less than or equal to 80°, and particularly preferably 45°, with the main extension plane of the contact side, i.e. with the contact surface. The ratio B/H is preferably greater than or equal to 0.2 and less than or equal to 5 and particularly preferably 1. Furthermore, the ratio H/D is preferably greater than 0 and less than or equal to 0.8 and particularly preferably greater than or equal to 0.1 and less than or equal to 0.5.

Furthermore, the recess can be formed by a combination of a rabbet and a fillet. In other words, the transition from the first to the second recess surface can be formed by a curved recess surface, preferably with a cross-section corresponding to a circular section. The fillet can have a radius R, the ratio R/D being preferably greater than or equal to 0.05 and less than or equal to 2. The ratio B/H is preferably greater than or equal to 0.2 and less than or equal to 10 and more preferably 1. Furthermore, the ratio H/D is preferably greater than 0 and less than or equal to 0.8 and more preferably greater than or equal to 0.1 and less than or equal to 0.5.

According to a further embodiment, at least one contact of the switching device has a plurality of recesses in different areas, in particular in different lateral directions, on the contact side. The recesses can be separate from one another or merge into one another. Furthermore, different or identical recesses can be present, for example, on different lateral sides and thus on different outer surfaces of the contact. Thus, it is possible that different formations of recesses are formed on different sides. Furthermore, different contacts can also have different recesses.

According to a further embodiment, the contact surface of a fixed contact, in a lateral direction, overhangs and/or is congruent with at least a part of the contact surface of the movable contact. For example, the contact surface of a fixed contact has a first width and a contact surface of the movable contact has a second width, wherein the first and second widths are measured along the same lateral direction and the first width is equal to or preferably greater than the second width. If the switching device has two fixed contacts that can be electrically connected to each other by a movable contact, the lateral direction along which the first and second widths are measured is preferably perpendicular to a connecting line between the centers of the contact surfaces of the two fixed contacts, in which case the first width of each of the fixed contacts is equal to or preferably greater than the second width. Particularly preferably, the contact region of each of the fixed contacts also overhangs the contact region of the movable contact in a lateral direction parallel to a connecting line between the centers of the contact regions of the two fixed contacts.

In particular, one or more recesses can be formed on the contact side of the movable contact in one or more areas where the contact surface of a fixed contact overhangs the contact surface of the movable contact.

In the switching device described here, so-called sacrificial regions can be provided in that a fixed contact projects beyond a movable contact in the lateral direction and/or in that one or more recesses are present on the contact side of one or more contacts. An arc occurring at a contact region can easily jump over to a sacrificial region, whereby damage caused by arcs in the sacrificial regions advantageously does not lead to a deterioration of the contact resistance between the contact regions. This can be achieved by arcs traveling along and down the described formations in the edges of the contacts and thus not being able to burn on the contact regions for a long time.

### BRIEF DESCRIPTION OF THE DRAWINGS

Further advantages, advantageous embodiments and developments are revealed in the exemplary embodiments described below in association with the figures.

FIG. 1 shows a schematic illustration of an example of a switching device according to an embodiment;

FIG. 2 shows a schematic illustration of a part of a switching device according to a further embodiment;

FIGS. 3A and 3B show schematic illustrations of parts of a switching device according to further embodiments;

FIGS. 4A and 4B show schematic illustrations of parts of a switching device according to further embodiments; and

FIGS. 5A to 6G show schematic illustrations of parts of a switching device according to further embodiments.

### DETAILED DESCRIPTION OF ILLUSTRATIVE EMBODIMENTS

In the exemplary embodiments and figures, identical, similar or identically acting elements may each be denoted by the same reference signs. The elements illustrated and their mutual proportions should not be considered true to scale; instead, individual elements, for example layers, components, structural elements and regions, may be shown exaggerated in size for better illustration and/or for better understanding.

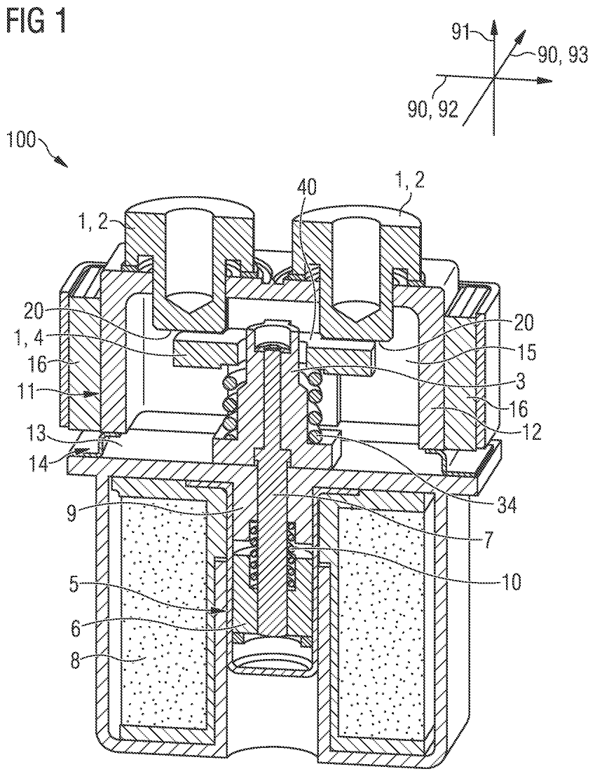

FIG. 1 shows an embodiment of a switching device 100 which can be used, for example, for switching strong electric currents and/or high electric voltages and which can be a relay or contactor, in particular a power contactor. FIG. 1 shows a three-dimensional sectional view with a vertical sectional plane. The geometries shown are only exemplary and are not to be understood as limiting and can also be designed alternatively.

The switching device 100 has contacts 1 in a housing (not shown), which are also referred to below as switching contacts. The housing serves primarily as contact protection for the components arranged inside and has a plastic or is made of plastic, for example PBT or glass fiber-filled PBT. In the embodiment shown, the switching device 100 has as contacts 1 two fixed contacts 2 and a movable contact 4 mounted on an insulator 3. The movable contact 4 is configured as a contact plate. The fixed contacts 2 together with the movable contact 4 form the switching contacts. As an alternative to the number of contacts shown, other numbers of contacts 1, i.e. other numbers of stationary and/or movable contacts, can also be possible. The fixed contacts 2 and/or the movable contact 4 can, for example, be made with or of Cu, a Cu alloy, one or more refractory metals such as, for example, Wo, Ni and/or Cr, or a mixture of said materials, for example of copper with at least one further metal, for example Wo, Ni and/or Cr.

In FIG. 1, the switching device 100 is shown in a switched-off state in which the movable contact 4 is spaced apart from the fixed contacts 2, so that the contacts 2, 4 are electrically isolated from each other. The shown embodiment of the switching contacts and in particular their geometry are to be understood as purely exemplary and not limiting. Alternatively, the switching contacts can also be designed differently.

The switching device 100 has a movable armature 5 that substantially performs the switching movement. The armature 5 comprises a magnetic core 6, for example with or made of a ferromagnetic material. Furthermore, the armature 5 has a shaft 7 which is guided through the magnetic core 6 and is fixedly connected to the magnetic core 6 at one shaft end. At the other shaft end opposite the magnetic core 6, the magnetic armature 5 has the movable contact 4, which is also connected to the shaft 7. The shaft 7 can preferably be made with or of stainless steel.

To electrically insulate the movable contact 4 from the shaft 7, the insulator 3, which can also be referred to as a bridge insulator, is arranged between them. To mount the movable contact 4 on the insulator 3, the insulator 3 can be inserted into an opening in the movable contact 4 in a position rotated about the shaft 7. The opening in the movable contact 4 and the shape of the insulator 3 are selected in such a way that, when the movable contact 4 is rotated relative to the insulator 3 into the correct installation position, locking of the movable contact 4 on the insulator 3 in an upward direction can be achieved, so that the movable contact 4 can no longer slip off the insulator 3. For example, latching lugs on the insulator 3 and, as counterparts, grooves in the opening of the movable contact 4 can be provided for this purpose. At the same time, the opening in the movable contact 4 can be large enough so that the movable contact 4, when installed, can still be tilted slightly with respect to the shaft 7 and shifted along the shaft 7 so that any height differences that can exist can be compensated for. To support the compensation of possible height differences and to ensure sufficient mechanical contact between the fixed contacts 2 and the contact bridge 4, a contact spring 34 is arranged below the movable contact 4, which is supported on the insulator 3 and which exerts a force in the direction of the fixed contacts 2 on the movable contact 4.

The magnetic core 6 is surrounded by a coil 8. A current flow in the coil 8, which can be switched on from outside by a control circuit, generates a movement of the magnetic core 6 and thus of the entire armature 5 in the axial direction until the movable contact 4 contacts the fixed contacts 2. In the illustration shown, the armature moves upward. The armature 5 thus moves from a first position, a rest position, which corresponds to the disconnecting, i.e. non-through-connecting and thus switched-off state, to a second position, which corresponds to the active, i.e. through-connecting and thus switched-on state. In the active state, the contacts 1 are galvanically connected to each other.

For guiding the shaft 7 and thus the magnetic armature 5, the switching device 100 has a yoke 9, which can have or be pure iron or a low-doped iron alloy and which forms part of the magnetic circuit. The yoke 9 has an opening in which the shaft 7 is guided. When the current flow in the coil 8 is interrupted, the magnetic armature 5 is moved back to the first position by one or more springs 10. In the embodiment shown, the armature 5 thus moves back down. The switching device 100 is then again in the rest state, in which the contacts 1 are open.

The direction of movement of the armature 5 and thus of the movable contact 4 is also referred to below as vertical direction 91. The direction of arrangement of the fixed contacts 2, which is perpendicular to the vertical direction 91, is referred to below as the longitudinal direction 92. The direction perpendicular to the vertical direction 91 and perpendicular to the longitudinal direction 92 is hereinafter referred to as the transverse direction 93. Directions 91, 92 and 93, which also apply independently of the described switching motion, are indicated in some figures to facilitate orientation. Directions parallel to a plane spanned by the longitudinal direction 92 and the transverse direction 93, and thus perpendicular to the vertical direction 91, are also referred to as lateral directions 90.

For example, when opening the contacts 1, at least one electric arc can be generated which can damage the contact surfaces of the contacts 1. As a result, there can be a risk that the contacts 1 can “stick” to each other due to a welding caused by the arc and can no longer be separated from each other. The switching device 100 then continues to be in the switched-on state, although the current in the coil 8 is switched off and thus the load circuit should be disconnected. In order to prevent such arcs from occurring, or at least to assist in extinguishing arcs that do occur, the contacts 1 can be arranged in a gas atmosphere, so that the switching device 100 can be configured as a gas-filled relay or gas-filled contactor. For this purpose, the contacts 1 are arranged within a switching chamber 11, formed by a switching chamber wall 12 and a switching chamber base 13, in a gas-tight area 14 formed by a hermetically sealed part, wherein the switching chamber 11 can be part of the gas-tight area 14. The gas-tight area 14 completely surrounds the armature 5 and the contacts 1, except for parts of the fixed contacts 2 provided for external connection. The gas-tight area 14, and thus also the interior 15 of the switching chamber 11, are filled with a gas. The gas-tight area 14 is essentially formed by parts of the switching chamber 11, the yoke 9 and additional walls. The gas, which can be filled into the gas-tight area 14 through a gas filling nozzle as part of the manufacturing of the switching device 100, can particularly preferably be hydrogen-containing, for example with 20% or more H₂ in an inert gas or even with 100% H₂, since hydrogen-containing gas can promote the extinguishing of arcs.

The switching chamber wall 12 and the switching chamber base 13 can, for example, be made with or from a metal oxide such as Al₂O₃. Furthermore, plastics with a sufficiently high temperature resistance are also suitable, for example a PEEK, a PE and/or a glass fiber-filled PBT. Alternatively or additionally, the switching chamber 11 can also comprise, at least in part, a POM, in particular with the structure (CH₂O₎n. Such a plastic can be characterized by a comparatively low carbon content and a very low tendency to form graphite. Due to the equal proportions of carbon and oxygen, particularly in the case of (CH₂O)ₙ, predominantly gaseous CO and H₂ can be formed during a heat-induced and, in particular, an arc-induced decomposition. The additional hydrogen can enhance arc quenching.

The features of the switching device 100 described above are to be understood as purely exemplary and not limiting. For example, as an alternative to the described embodiment as a gas-filled contactor, the switching device 100 can also be configured without gas filling. For example, based on the design of the contacts 1 described below, it can be possible, as also described in the general part, that so-called sacrificial regions are formed at one or more contacts 1 where arcs can migrate away from the contact surfaces, so that, among other things, a tendency for arcing to cause welding of contacts can be reduced. Therefore, it can also be possible for the switching device 100 to be configured without a gas-tight area.

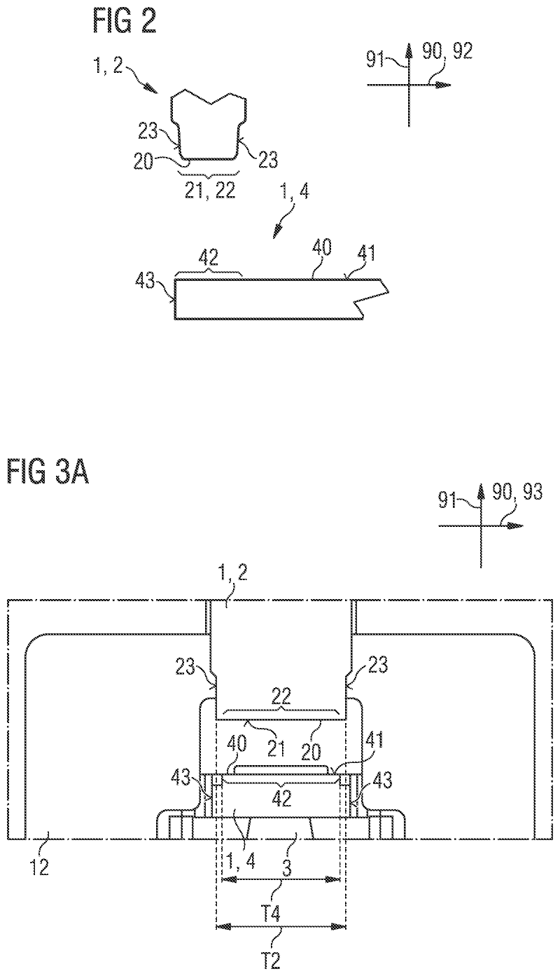

As can be seen in FIG. 1, each of the contacts 1 has a respective contact side 20, 40, with the contact side 20 of each of the fixed contacts 2 facing the movable contact 4 and the contact side 40 of the movable contact 4 facing each of the fixed contacts 2. In FIG. 2, a cutaway view of a fixed contact 2 and the movable contact 4 is indicated. The respective surface on the contact side 20, 40 forms the contact surface 21, 41 of the fixed and movable contacts 2, 4. The contact surfaces 21, 41 each have contact regions 22, 42. The contact region 22, 42 of each of the contacts 1 can in particular be that part of the respective contact surface 21, 41 which, in a normal mode of operation of the switching device 100, is intended and configured to make mechanical contact with a further contact when the switching device 100 is switched on. In this regard, not every region of a contact surface need be formed as a contact region. Furthermore, the contact surface of a contact can also have more than one contact region, as is the case with the movable contact 4 in the switching device 100 shown, which has a respective associated contact region 42 on the contact surface 41 for each of the fixed contacts 2, which are separated from one another by an area of the contact surface 41 which is not provided as a contact region. As can also be seen in FIG. 1, the movable contact 4 can, for example, have a contact surface 41 which has an elongated configuration with a main direction of extension in the longitudinal direction 92, in particular in the form of a rectangle or approximating the shape of a rectangle, such as a rectangle with chamfered or rounded corners.

In the embodiment shown, the contact surface 21 of each of the fixed contacts 2 completely or at least substantially completely forms the respective contact region 22. For example, the contact region 22 of a fixed contact can comprise at least 70% or at least 80% or at least 90% of the contact surface 21. Preferably, the contact surface 21 and thus the contact region 22 of the fixed contacts 2 can have a round shape, such as a circular shape, or can be approximated thereto. Correspondingly, the contact regions 42 of the movable contact 4 can have a round shape or be approximated thereto.

For example, a contact region 22, 42 of a contact 1 can be a flat bearing surface of the contact surface 21, 41. Alternatively, the contact region 22, 42 can have or be a special geometric shape, such as an elevation or depression, and/or a different material compared to other areas of the contact.

In the lateral directions 90, i.e. for example in the longitudinal direction 92 visible in FIG. 2, the contacts 1 are bounded by outer surfaces 23, 43. The distances of outer surfaces 23, 43 opposite each other in a lateral direction 90 can particularly preferably define the maximum extension of a contact along this lateral direction 90.

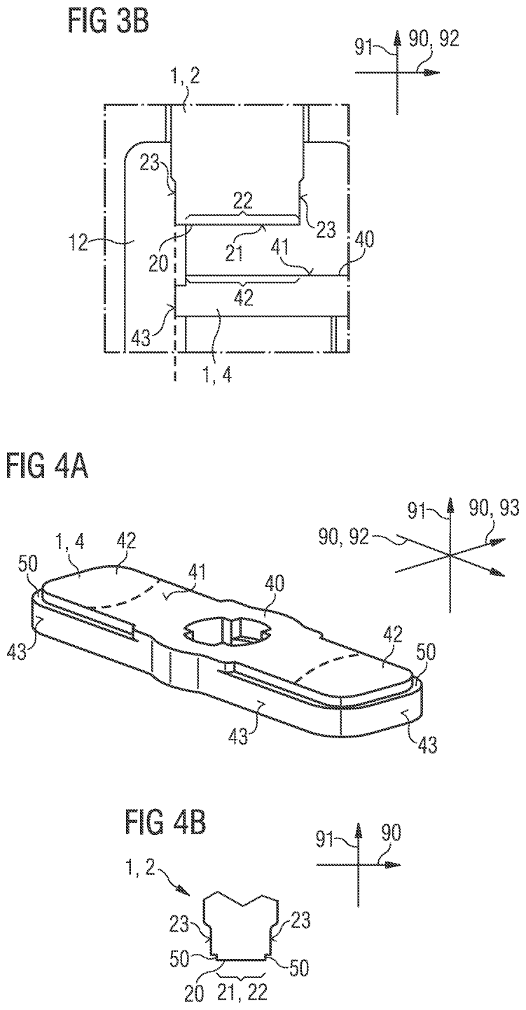

Preferably, the entire contact surfaces 21 of the fixed contacts 2 are congruent with a portion of the contact surface 41 of the movable contact 4 or project beyond the contact surface 41 and thus the contact regions 42 of the movable contact 4 in several lateral directions 90, as indicated in FIGS. 3A and 3B in sections of the switching device. For example, the contact surface 21 of each of the fixed contacts 2 has a first width T2 and the contact surface 41 of the movable contact 4 has a second width T4, wherein the first and second widths T2, T4 are measured along the same lateral direction 90. In the illustrated embodiment of FIG. 3A, the widths T2 and T4 are the widths of the contact surfaces 21, 41 in the transverse direction 93. The first width T2 of the contact surface 21 of each of the fixed contacts 2 is equal to or preferably, as shown in FIG. 3A, greater than the second width T4 of the contact surface 41 of the movable contact 4.

Furthermore, the respective contact surface 21 of the fixed contacts 2 preferably also projects in longitudinal direction 92 beyond the contact surface 41 of the movable contact 4, as can be seen in the embodiment example of FIG. 3B. In this case, as can also be seen in FIG. 3B, the outer surfaces 23, 43 of the contacts 1 can be congruent in at least one lateral direction 90. This can also be the case in the transverse direction 93. Furthermore, as can be seen in FIG. 3A in the transverse direction 93, for example, the outer surfaces 43 of the movable contact 4 can project beyond the outer surfaces 23 of the fixed contacts 2 in lateral direction 90. Alternatively, a reverse design can also be possible.

With regard to the previously described configurations of the contacts 1 with respect to each other, it can be particularly advantageous if at least one contact 1 of the switching device has at least one recess 50 on the contact side 20, 40. This means that the contact surface 21, 41 does not extend, in the lateral direction, as far as an outer surface 23, 43 bounding the contact 1, but is separated from the outer surface 23, 43 by a step or chamfer, for example. The at least one contact 1 with the at least one recess 50 can preferably be a movable contact 4, as shown in the embodiment example of FIG. 4A. In this case, a recess 50 can be formed on one outer surface 43, on two outer surfaces 43 opposite each other in a lateral direction 90, or also, at least in the region of the contact regions, on all outer surfaces 43, as can be seen in FIG. 4A. The movable contact 4 shown in FIG. 4A thus has for each of the contact regions 42 indicated by the dashed lines a special edge shape formed by the recess present on all three possible deflection sides for arcs.

Alternatively or additionally, the fixed contacts 2 can also have at least one recess 50, as shown in the embodiment of FIG. 4B. In the case of the fixed contacts 2, the recess 50 can preferably be formed in all lateral directions 90 on the outer surfaces 23.

As can be seen in FIGS. 4A and 4B, a recess 50 can be formed by a groove or chamfer that extends along an imaginary edge that would be present between the contact surface and an outer surface without the groove or chamfer and that is no longer present between the contact surface 21, 41 and the outer surface 23, 43 due to the groove or chamfer.

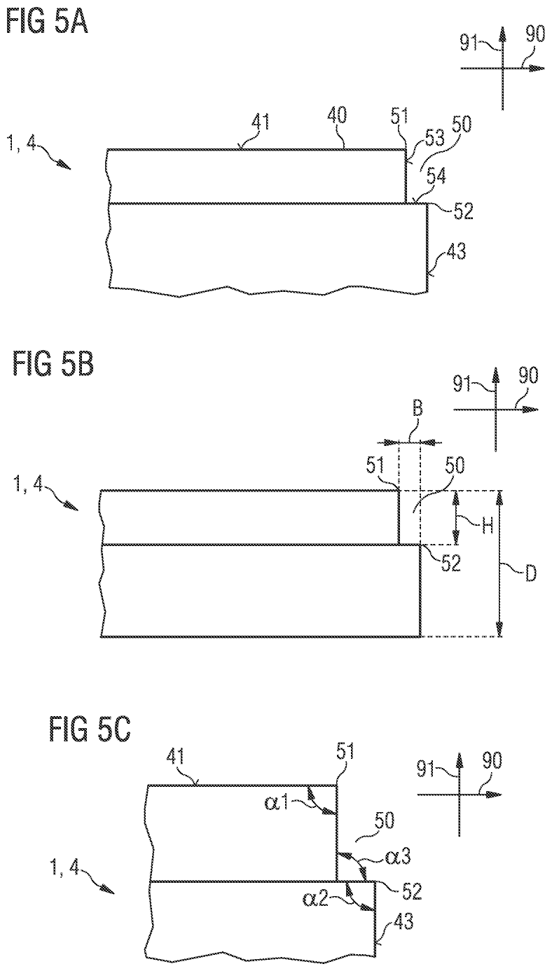

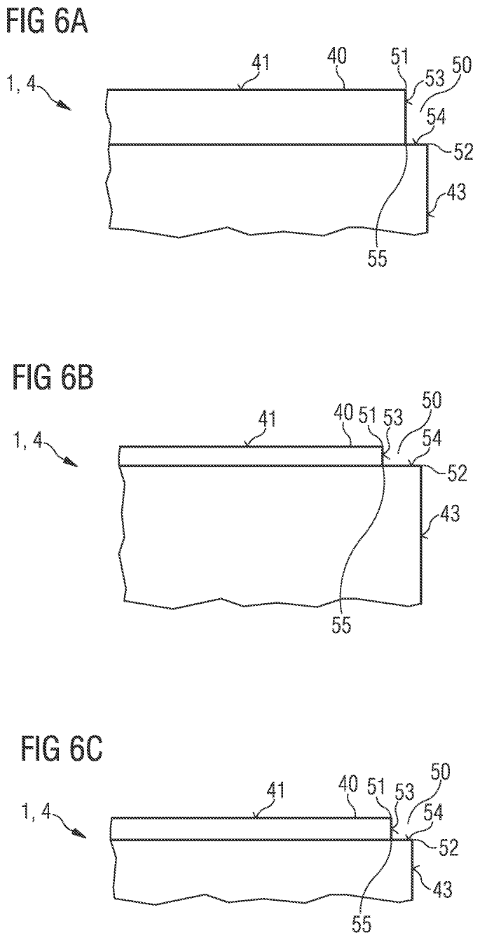

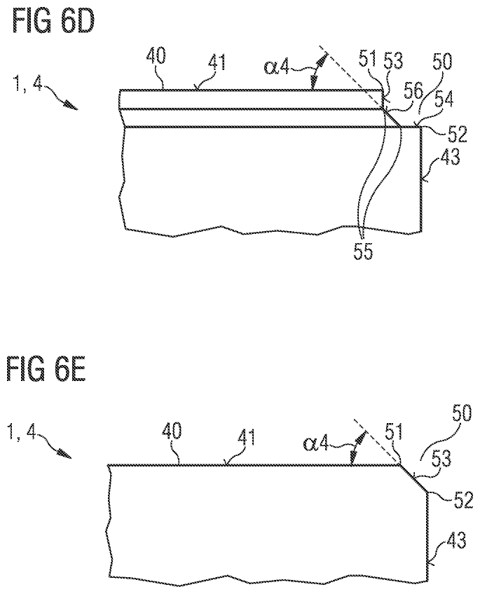

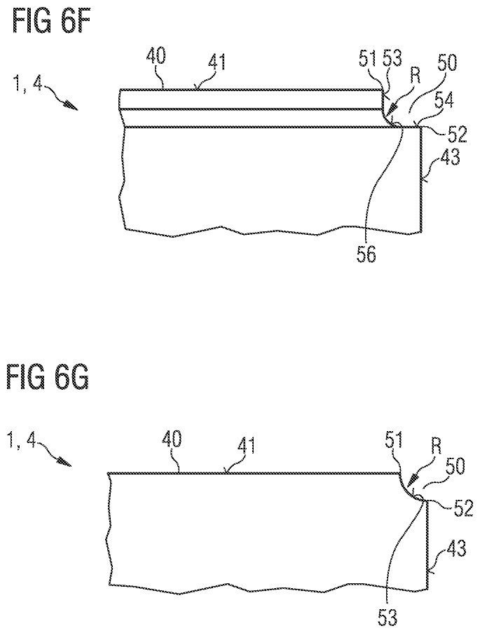

In FIGS. 5A to 5C and also in FIGS. 6A to 6G, sections of a contact 1 with a recess 50 on the outer surface 43 bounding in the longitudinal direction 92 are shown purely as an example based on the movable contact 4. Various embodiments for the recess are shown in FIGS. 6A to 6G. The following description for various embodiments of the recess expressly applies equally to fixed contacts. Furthermore, the same or different recess configurations are possible on different sides, i.e. in different lateral directions. For example, in the case of the movable contact 4, a first configuration of the recess can be provided on the outer surfaces in the transverse direction, while a second configuration of the recess can be provided on the outer surfaces in the longitudinal direction, which is different from the first configuration.

As shown in FIGS. 5A to 5C, two outer edges 51, 52 are formed by the recess 50, a first outer edge 51 of which is adjacent to the contact surface 41 and a second outer edge 52 of which is adjacent to the outer surface 43. The first and second outer edges 51, 52 can be interconnected by one or more recess surfaces 53, 54. In FIG. 5B, dimensions H, B for the recess 50 and the thickness D of the contact 1 are indicated. The dimensions H, B indicated in FIG. 5B apply to all embodiments of the recess 50 shown below, since they each refer to the always present outer edges 51, 52 regardless of the shape of the recess 50. Even if the outer edges 51, 52 are indicated as pointed edges, these can also be rounded or chamfered, in which case the dimensions given below apply mutatis mutandis.

The height of the recess 50, i.e. the distance in the vertical direction 91 between the first outer edge 51 and the second outer edge 52, is denoted by H in the following. The width of the recess 50, i.e. the distance in lateral direction 90 between the first outer edge 51 and the second outer edge 52, is denoted by B in the following. A total thickness of the contact in vertical direction 91 is denoted by D in the following.

As indicated in FIG. 5C, the contact surface 41 includes a first angle α1 with the adjacent first recess surface 53 at the first outer edge 51, while the outer surface 43 includes a second angle α2 with the adjacent second recess surface 54 at the second outer edge 52. The first recess surface 53 and the second recess surface 54 can include a third angle α3.

For example, the recess can have a step, in particular, as indicated in FIGS. 5A and 5B, a rabbet, or can have or be formed by a chamfer, a fillet, or a combination thereof. The chamfer can be an external chamfer or an internal chamfer.

Unless shown in FIGS. 6A to 6G described below, the dimensions and angles described below refer to those described in connection with FIGS. 5A to 5C.

In connection with FIGS. 6A to 6C, embodiments for a contact 1 with recess 50 are shown in sections, wherein the recess 50 is formed by a step in the form of a rabbet. The first, second and third angles α1, α2, α3 can be equal to or different from each other and can each be greater than or equal to 90° and less than 180° and preferably each can be 90°. Particularly preferably, the first recess surface 53 can be at least partially or completely parallel to the outer surface 43. Furthermore, the second recess surface 54 can be at least partially or completely parallel to the contact surface 41. When the first and second angles α1, α2 are each 90°, the distance H can correspond to the difference in height in the vertical direction between the second recess surface 54 and the contact surface 41, while the distance B can correspond to the distance in the lateral direction 90 between the outer surface 43 and the first recess side surface 53.

In the rabbet shown in FIGS. 6A to 6C, the transition between the first and second recess surfaces 53, 54 is formed by an inner edge 55, wherein the third angle α3 at the inner edge 55 is preferably 90°. The first and second angles α1, α2 can also preferably be 90° each in this case. The ratio B/H is preferably greater than or equal to 0.2 and less than or equal to 5 and particularly preferably 1. Furthermore, the ratio H/D is preferably greater than 0 and less than or equal to 0.8 and particularly preferably greater than or equal to 0.1 and less than or equal to 0.5. FIG. 6A shows an example of a rabbet with B/H=0.5. Here, for example, B=0.5 mm and H=1 mm. FIG. 6B shows an example of a rabbet with a ratio B/H=2, where, for example, B=1 mm and H=0.5 mm. FIG. 6C shows an example of a rabbet with B/H=1, where, for example, B=1 mm and H=1 mm.

As shown in FIG. 6D, the recess 50 can have an internal chamfer. In this case, the recess 50 can be formed by a combination of a rabbet and a chamfer. Compared to a rabbet having an inner edge 55 between the first and second recess surfaces 53, 54 as shown in FIGS. 6A to 6C, the transition between the first and second recess surfaces 53, 54 is formed by a chamfer in the form of the inner bevel rather than an inner edge, so that a third recess surface 56 is formed between the first and second recess surfaces 53, 54. In this case, the first and second recess surfaces 53, 54 are connected to each other by the planar third recess surface 56, which is oriented at an angle to the first and second recess surfaces 53, 54, forming two inner edges 55. The third recess surface 56 preferably includes with the main extension plane of the contact surface 41 an angle α4, which is thus the angle of the inner chamfer and which is greater than or equal to 10° and less than or equal to 80° and particularly preferably of 45°. The ratio B/H is preferably greater than or equal to 0.2 and less than or equal to 5 and more preferably 1. Furthermore, the ratio H/D is preferably greater than 0 and less than or equal to 0.8 and more preferably greater than or equal to 0.1 and less than or equal to 0.5.

Furthermore, as shown in FIG. 6E, the recess 50 can be formed by an outer chamfer, i.e. by a chamfer in the area of an outer edge between the contact surface 41 and the outer surface 43 which is no longer present due to the chamfer. In this case, the first and second outer edges 51, 52 are connected to each other by a planar recessed surface 53 which is oriented at an angle to the contact surface 41 and to the outer surface 43 and which can preferably include an angle α4, i.e. a chamfer angle, of greater than or equal to 10° and less than or equal to 80° and particularly preferably of 45° with the main extension plane of the contact surface 41. The ratio B/H is preferably greater than or equal to 0.2 and less than or equal to 5 and particularly preferably 1. Furthermore, the ratio H/D is preferably greater than 0 and less than or equal to 0.8 and particularly preferably greater than or equal to 0.1 and less than or equal to 0.5.

As shown in FIG. 6F, the recess 50 can also be formed by a combination of a rabbet and a fillet. In other words, the transition from the first to the second recess surface 53, 54 can be formed by a curved recess surface 56, preferably with a cross-section corresponding to a circular section. The fillet can have a radius R, the ratio R/D being preferably greater than or equal to 0.05 and less than or equal to 2. The ratio B/H is preferably greater than or equal to 0.2 and less than or equal to 10 and more preferably 1. Furthermore, the ratio H/D is preferably greater than 0 and less than or equal to 0.8 and more preferably greater than or equal to 0.1 and less than or equal to 0.5.

Furthermore, as shown in FIG. 6G, the recess 50 can be formed by a fillet, that is, by a groove with a circular cross-section in the region of an outer edge between the contact surface 41 and the outer surface 43, which is no longer present due to the groove. In this case, the first and second outer edges 51, 52 are connected to each other by a curved recess surface 53, preferably with a cross-section corresponding to a circular section. The fillet can have a radius R, the ratio R/D being preferably greater than or equal to 0.05 and less than or equal to 2. The ratio B/H is preferably greater than or equal to 0.2 and less than or equal to 10 and particularly preferably 1. Furthermore, the ratio H/D is preferably greater than 0 and less than or equal to 0.8 and particularly preferably greater than or equal to 0.1 and less than or equal to 0.5.

The recess side surfaces can form so-called sacrificial regions onto which an arc can “jump” that occurs between the contact surfaces of a fixed contact and the movable contact. This can be facilitated, in particular, by the fact that at least one contact surface projects beyond, or is at least congruent with, an opposite contact surface with a recess in the lateral direction. In this way, arcs can be kept away from the contact surfaces so that the risk of damage to the contact surfaces and in particular the contact regions caused by arcs and an associated deterioration of the contact resistance can be reduced.

The features and exemplary embodiments described in association with the figures can be combined with one another according to further exemplary embodiments, even if not all combinations have been explicitly described. The exemplary embodiments described in association with the figures can furthermore alternatively or additionally have further features according to the description in the general part.

The description based on the exemplary embodiments does not restrict the invention thereto. Instead, the invention comprises any novel feature and any combination of features, which, in particular, includes any combination of features in the claims, even if this feature or this combination itself is not explicitly specified in the claims or exemplary embodiments.

1.-14. (canceled)

15. A switching device comprising:
at least two contacts in a switching chamber,
wherein the at least two contacts comprise a fixed contact and a movable contact,
wherein each of the contacts has a contact surface with at least one contact region on a contact side, and
wherein at least one of the contacts has at least one recess.

16. The switching device according to claim 15, wherein the fixed contact has a contact surface protruding in at least one lateral direction beyond the contact surface of the movable contact.

17. The switching device according to claim 15, wherein the at least one movable contact has at least one recess on the contact side.

18. The switching device according to claim 15, wherein the at least one fixed contact has at least one recess on the contact side.

19. The switching device according to claim 15, wherein each of the contacts comprises at least one recess.

20. The switching device according to claim 15, wherein the at least one recess is formed by a groove or chamfer extending along an imaginary edge, which would be formed by the contact surface and an outer surface and which is no longer present, due to the groove or the chamfer, between the contact surface and the outer surface.

21. The switching device according to claim 15, wherein a first outer edge adjacent to the contact surface and a second outer edge adjacent to an outer surface are formed by the recess.

22. The switching device according to claim 21, wherein the first and second outer edges are interconnected by one or more recess surfaces.

23. The switching device according to claim 21,
wherein the contact surface has a main extension plane, directions parallel to the main extension plane are lateral directions and directions perpendicular to the main extension plane are vertical directions,
wherein a distance of the first outer edge and the second outer edge in a vertical direction is denoted by H and in a lateral direction is denoted by B, and
wherein B/H is greater than or equal to 0.2 and less than or equal to 5.

24. The switching device according to claim 23, wherein a total thickness of the contact in a vertical direction is denoted by D, and wherein H/D is greater than 0 and less than or equal to 0.8.

25. The switching device according to claim 23, wherein the recess comprises at least one curved recess surface having a cross-section corresponding to a circular section with a radius R, and wherein R/D is greater than or equal to 0.05 and less than or equal to 2.

26. The switching device according to claim 15, wherein the recess comprises at least one recess surface that includes an angle of greater than or equal to 10° and less than or equal to 80° with the contact surface.

27. The switching device according to claim 15, wherein the recess comprises a rabbet, chamfer, fillet, or combination thereof.

28. The switching device according to claim 15, wherein recesses are arranged on the contact side in different lateral directions.
